(19) United States
(12) Patent Application Publication
(10) Pub. No.: US 2013/0076138 A1
(43) Pub. Date: Mar. 28, 2013

(54) Cell parallel device

(71) Applicant: Chao-Cheng Lu, Taipei (TW)

(72) Inventor: Chao-Cheng Lu, Taipei (TW)

(21) Appl. No.: 13/200,621

(22) Filed: Sep. 28, 2011

(51) Int. Cl. H02J 1/10

(52) U.S. Cl. 307/51

(57) ABSTRACT

The invention related in cell parallel device is a circuit of SCR S1 to S4, comprises: a first terminal connected T1 to positive voltage terminal of first cell E1; a second terminal T2 connected to positive voltage terminal of second cell E2; and a third terminal T3 connected to voltage positive terminal of charge element CD or load LD, and trigger element TE connected between gate and anode of the SCR S1 to S4, the negative voltage terminal of charge element CD or load LD connected to negative voltage terminal of first cell E1 and second cell E2, can be not occur loop current in cells parallel circuit.

### BACKGROUND OF THE INVENTION

1. The Field of the Invention

The present invention relates a cell parallel device, comprises a first terminal, a second terminal and a third terminal, the first terminal connected to a first cell, the second terminal connected to second cell, the third terminal connected to charge device or load terminal, the function of the present invention can be not occur loop current in cells parallel circuit.

2. Description of Related Art

FIG. 10 shows a schematic diagram of a prior art circuit. The first cell EA and second cell EB use conventional parallel circuit. Such scheme comes with the following drawbacks:
1. When operation of charge of the first cell EA and second cell EB, can be occur loop current between the first cell EA and second cell EB, con be occur power consumption.
2. When operation of discharge of the first cell EA and second cell EB, can be occur loop current between the first cell EA and second cell EB, con be occur power consumption.
3. When operation of no load of the first cell EA and second cell EB, can be occur loop current between the first cell EA and second cell EB, con be occur power consumption.

### SUMMARY OF THE INVENTION

In order to provide cell parallel device that may in charge or discharge or no load can be not occur loop current in cells parallel circuit, the present invention is proposed the following:

The first object of the invention is to provide Thyristor for a cell parallel device.

The second object of the invention is use the trigger element to control Thyristor trigger voltage can be not occur loop current in cells parallel circuit.

The third object of the invention is use the trigger element, comprises Diode for Alternating Current (DIAC), Silicon Diode for Alternating Current (SIDAC) and diode.

The fourth object of the present invention is use for secondary cells.

### BRIEF DESCRIPTION OF THE DRAWINGS

Embodiment of the invention will be described in more detail hereinafter with reference to the accompanying drawing. In the drawings:

FIG. 1 shows a circuit diagram of a first embodiment of the present invention.

FIG. 2 shows a circuit diagram of a second embodiment of the present invention.

FIG. 3 shows a circuit diagram of a third embodiment of the present invention.

FIG. 4 shows a circuit diagram of a fourth embodiment of the present invention.

FIG. 5 shows a circuit diagram of a fifth embodiment of the present invention.

FIG. 6 shows a circuit diagram of a sixth embodiment of the present invention.

FIG. 7 shows a circuit diagram of a first cell parallel device circuit of the present invention.

FIG. 8 shows a circuit diagram of a second cell parallel device circuit of the present invention.

FIG. 9 shows a circuit diagram of a third cell parallel device circuit of the present invention.

FIG. 10 shows a schematic diagram of a prior art circuit.

### DESCRIPTION OF THE PREFERRED EMBODIMENT

FIG. 1 shows a circuit diagram of a first embodiment of the present invention.

In FIG. 1, positive voltage terminal of the first cell E1 connected to first terminal T1, cathode K1 of the first SCR S1 and anode A2, gate G2 of the second SCR S2 form a first terminal T1; positive voltage terminal of the second cell E2 connected to second terminal T2, cathode K3 of the third SCR S3 and anode A4, gate G4 of the fourth SCR S4 form a second terminal T2; anode A1, gate G1 of the first SCR S1 and cathode K2 of the second SCR S2, and anode A3, gate G3 of the third SCR S3 and cathode K4 of the fourth SCR S4 are connected together form a third terminal T3, can be connected to charge device CD or load LD; negative voltage terminal of the first cell E1 and negative voltage terminal of the second cell E2 can be connected to charge device CD or load LD.

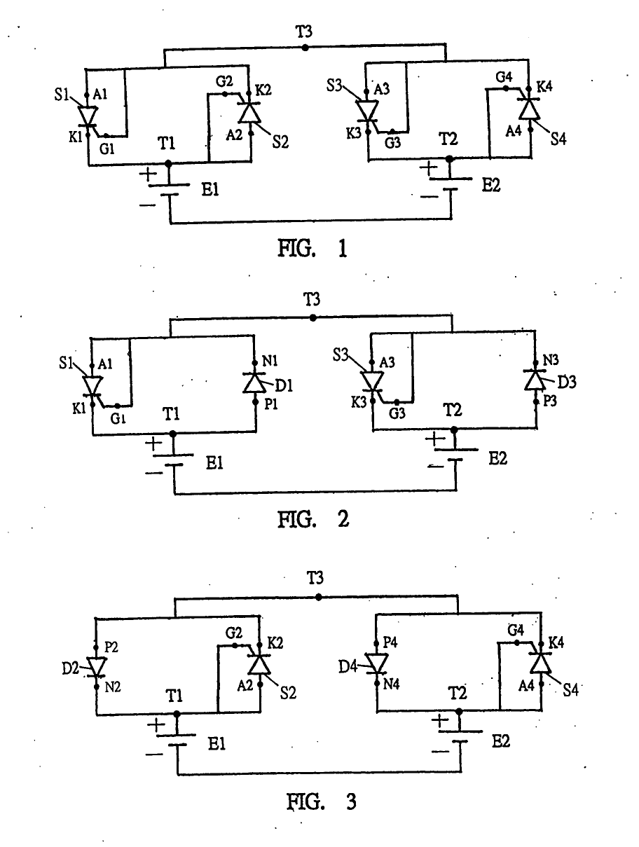

FIG. 2 shows a circuit diagram of a second embodiment of the present invention. In FIG. 2, the first diode D1 have replaced second SCR S2 of FIG. 1, the N junction N1 of first diode D1 connected to third terminal T3, the P junction P1 of first diode D1 connected to first terminal T1, the third diode D3 have replaced fourth SCR S4 of FIG. 1, the N junction N3 of third diode D3 connected to third terminal T3, the P junction P3 of third diode D3 connected to second terminal T2; the first diode D1 replaced second SCR S2, and the third diode D3 replaced fourth SCR S4, the object is cell parallel device circuit simplicity.

FIG. 3 shows a circuit diagram of a third embodiment of the present invention. In FIG. 3, the second diode D2 have replaced first SCR S1 of FIG. 1, the P junction P2 of second diode D2 connected to third terminal T3, the N junction N2 of second diode D2 connected to first terminal T1, the fourth diode D4 have replaced third SCR S3 of FIG. 1, the P junction P4 of fourth diode D4 connected to third terminal T3, the N junction N4 of fourth diode D4 connected to second terminal T2; the second diode D2 replaced first SCR S1, and the fourth diode D4 replaced third SCR S3, the object is cell parallel device circuit simplicity.

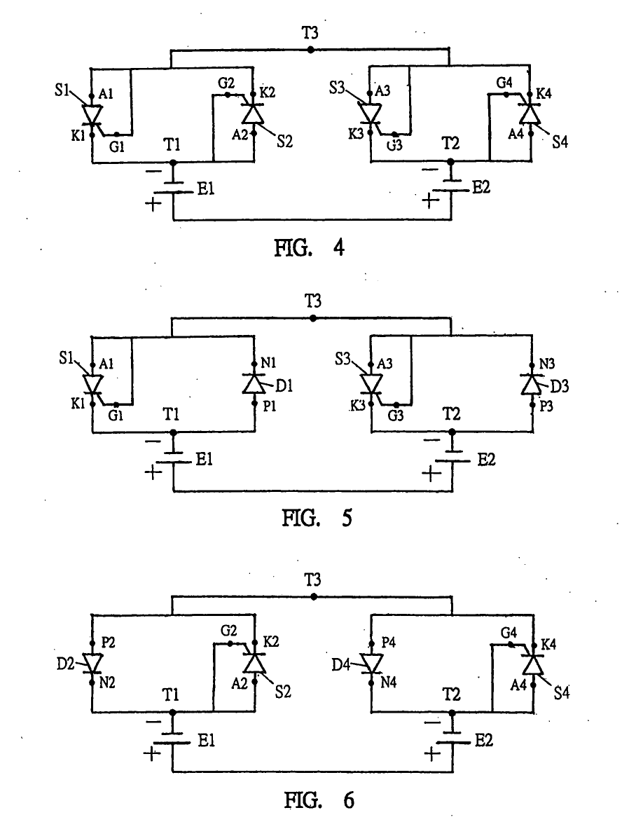

FIG. 4 shows a circuit diagram of a fourth embodiment of the present invention. In FIG. 4, negative voltage terminal of the first cell E1 connected to first terminal T1, cathode K1 of the first SCR S1 and anode A2, gate G2 of the second SCR S2 form a first terminal T1; negative voltage terminal of the second cell E2 connected to second terminal T2, cathode K3 of the third SCR S3 and anode A4, gate G4 of the fourth SCR S4 form a second terminal T2; anode A1, gate G1 of the first SCR S1 and cathode K2 of the second SCR S2, and anode A3, gate G3 of the third SCR S3 and cathode K4 of the fourth SCR S4 are connected together form a third terminal T3, con be connected to negative voltage terminal of charge device CD or load LD; positive voltage terminal of the first cell E1 and positive voltage terminal of the second cell E2 can be connected to positive voltage terminal of charge device CD or load LD.

FIG. 5 shows a circuit diagram of a fifth embodiment of the present invention. In FIG. 5, the first diode D1 have replaced second SCR S2 of FIG. 4, the N junction N1 of first diode D1 connected to third terminal T3, the P junction P1 of first diode D1 connected to first terminal T1, the third diode D3 have replaced fourth SCR S4 of FIG. 4, the N junction N3 of third diode D3 connected to third terminal T3, the P junction P3 of third diode D3 connected to second terminal T2; the first diode D1 replaced second SCR S2, and the third diode D3 replaced fourth SCR S4, the object is cell parallel device circuit simplicity.

FIG. 6 shows a circuit diagram of a sixth embodiment of the present invention. In FIG. 6, the second diode D2 have replaced first SCR S1 of FIG. 4, the P junction P2 of second diode D2 connected to third terminal T3, the N junction N2 of second diode D2 connected to first terminal T1, the fourth diode D4 have replaced third SCR S3 of FIG. 4, the P junction P4 of fourth diode D4 connected to third terminal T3, the N junction N4 of fourth diode D4 connected to second terminal T2; the second diode D2 replaced first SCR S1, and the fourth diode D4 replaced third SCR S3, the object is cell parallel device circuit simplicity.

FIG. 7 shows a circuit diagram of a first cell parallel device circuit of the present invention. In FIG. 7, the third terminal T3 of present invention connected to positive voltage terminal of charge device CD or load LD, the first terminal T1 of present invention connected to positive voltage terminal of first cell E1, the negative voltage terminal of first cell E1 connected to negative voltage terminal of charge device CD or load LD, the second terminal T2 of present invention connected to positive voltage terminal of second cell E2, the negative voltage terminal of second cell E2 connected to negative voltage terminal of charge device CD or load LD; the first terminal of first trigger element TE1 connected to third terminal T3 and second terminal of first trigger element TE1 connected to gate G1 of first SCR S1; the first terminal of second trigger element TE2 connected to first terminal T1 and second terminal of second trigger element TE2 connected to gate G2 of second SCR S2; the first terminal of third trigger element TE3 connected to third terminal T3 and second terminal of third trigger element TE3 connected to gate G3 of third SCR S3; the first terminal of fourth trigger element TE4 connected to second terminal T2 and second terminal of fourth trigger element TE4 connected to gate G4 of fourth SCR S4; the trigger element TE, comprises Diode for Alternating Current (DIAC), and Silicon Diode for Alternating Current (SIDAC), the DIAC is a diode that conducts current only after its breakover voltage has been reached momentarily, the SIDAC have higher breakover voltage and current handling, its operation is similar to that of DIAC, but SIDAC is always a five-layer device with low voltage drop in latched conducting state, and the diode is use for low trigger voltage of the SCR of present invention, one thing to be emphasized is use DIAC or SIDAC or diode shall not be limit of present invention.

In FIG. 7, the operation theorem of cell charge of present invention, while the positive voltage at positive voltage terminal of charge device CD, when the positive voltage over breakover voltage of first trigger element TE1 and third trigger element TE3, the first SCR S1 and third SCR S3 is turn on, the second SCR S2 and fourth SCR S4 is off state, the current of positive voltage passes through the first SCR S1, and positive voltage terminal of first cell E1, negative voltage terminal of first cell E1, and back to negative voltage terminal of charge device CD, another current of positive voltage passes through the third SCR S3, and positive voltage terminal of second cell E2, negative voltage terminal of second cell E2, and back to negative voltage terminal of charge device CD.

In FIG. 7, the operation theorem of cell discharge of present invention, while a load LD connected between positive voltage terminal and negative voltage terminal, the positive voltage of first cell E1 and second cell E2 over breakover voltage of second trigger element TE2 and fourth trigger element TE4, the second SCR S2 and fourth SCR S4 is turn on, the first SCR S1 and third SCR S3 is off state, the current of positive voltage of first cell E1 passes through the second SCR S2, positive voltage terminal of load LD, negative voltage terminal of load LD, and back to negative voltage terminal of first cell E1, another current of positive voltage of second cell E2 passes through the fourth SCR S4, positive voltage terminal of load LD, negative voltage terminal of load LD, and back to negative voltage terminal of second cell E2.

In FIG. 7, when the charge device CD and load LD is to take away, the anode A2 of the second SCR S2 connected to positive voltage terminal of first cell E1, cathode K2 of the second SCR S2 connected to cathode K4 of the fourth SCR S4, the anode A4 of fourth SCR S4 connected to positive voltage terminal of second cell E2, use breakover voltage technically specified of second trigger element TE2 and fourth trigger element TE4, the voltage potential difference of the first cell E1 and second cell E2 less than breakover voltage of second trigger element TE2 and fourth trigger element TE4, the second SCR S2 and fourth SCR S4 is turn off state, its can be not occur loop current between the first cell E1 and the second cell E2 parallel circuit.

FIG. 8 shows a circuit diagram of a second cell parallel device circuit of the present invention. In FIG. 8, the third terminal T3 of present invention connected to negative voltage terminal of charge device CD or load LD, the first terminal T1 of present invention connected to negative voltage terminal of first cell E1, the positive voltage terminal of first cell E1 connected to positive voltage terminal of charge device CD or load LD, the second terminal T2 of present invention connected to negative voltage terminal of second cell E2, the positive voltage of second cell E2 connected to positive voltage terminal of charge device CD or load LD; the first terminal of second trigger element TE2 connected to first terminal T1 and second terminal of second trigger element TE2 connected to gate G2 of second SCR S2; the first terminal of fourth trigger element TE4 connected to second terminal T2 and second terminal of fourth trigger element TE4 connected to gate G4 of fourth SCR S4; the first terminal of first trigger element TE1 connected to third terminal T3 and second terminal of first trigger element TE1 connected to gate G1 of first SCR S1; the first terminal of third trigger element TE3 connected to third terminal T3 and second terminal of third trigger element TE3 connected to gate G3 of third SCR S3; the trigger element TE, comprises Diode for Alternating Current (DIAC), Silicon Diode for Alternating Current (SIDAC), the DIAC is a diode that conducts current only after its breakover voltage has been reached momentarily, the SIDAC have higher breakover voltage and current handling, its operation is similar to that of DIAC, but SIDAC is always a five-layer device with low voltage drop in latched conducting state, and the diode is use for low trigger voltage of the SCR of present invention, one thing to be emphasized is use DIAC or SIDAC or diode shall not be limit of present invention.

In FIG. 8, the operation theorem of cell charge of present invention, while the positive voltage at positive voltage terminal of charge device CD, the positive voltage over breakover voltage of second trigger element TE2 and trigger element TE4, the second SCR S2 and fourth SCR S4 is turn on, the first SCR S1 and third SCR S3 is off state, the current of positive voltage passes through the first cell E1, second SCR S2 and back to negative voltage terminal of charge device CD, another current of positive voltage passes through the second cell E2, fourth SCR S4 and back to negative voltage terminal of charge device CD.

In FIG. 8, the operation theorem of cell discharge of present invention, while a load LD connected between positive voltage terminal and negative voltage terminal, when the positive voltage of first cell E1 and second cell E2 over breakover voltage of first trigger element TE1 and third trigger element TE3, the first SCR S1 and third SCR S3 is turn on, the second SCR S2 and fourth SCR S4 is off state, the current of positive voltage of first cell E1 passes through the positive voltage terminal of load LD, negative voltage terminal of load LD, and first SCR S1 and back to negative voltage terminal of first cell E1, another current of positive voltage of second cell E2 passes through the positive voltage terminal of load LD, negative voltage terminal of load LD, third SCR S3 and back to negative voltage terminal of second cell E2.

In FIG. 8, when the charge device CD and load LD is to take away, the cathode K1 of the first SCR S1 connected to negative voltage terminal of first cell E1, the anode A1 of first SCR S1 connected to anode A3 of third SCR S3, the cathode K3 of the third SCR S3 connected to negative voltage terminal of second cell E2, use breakover voltage technically specified of first trigger element TE1 and third trigger element TE3, the voltage potential difference of the first cell E1 and second cell E2 less than breakover voltage of first trigger element TE1 and third trigger element TE3, the first SCR S1 and third SCR S3 is turn off state, its can be not occur loop current between the first cell E1 and the second cell E2 parallel circuit.

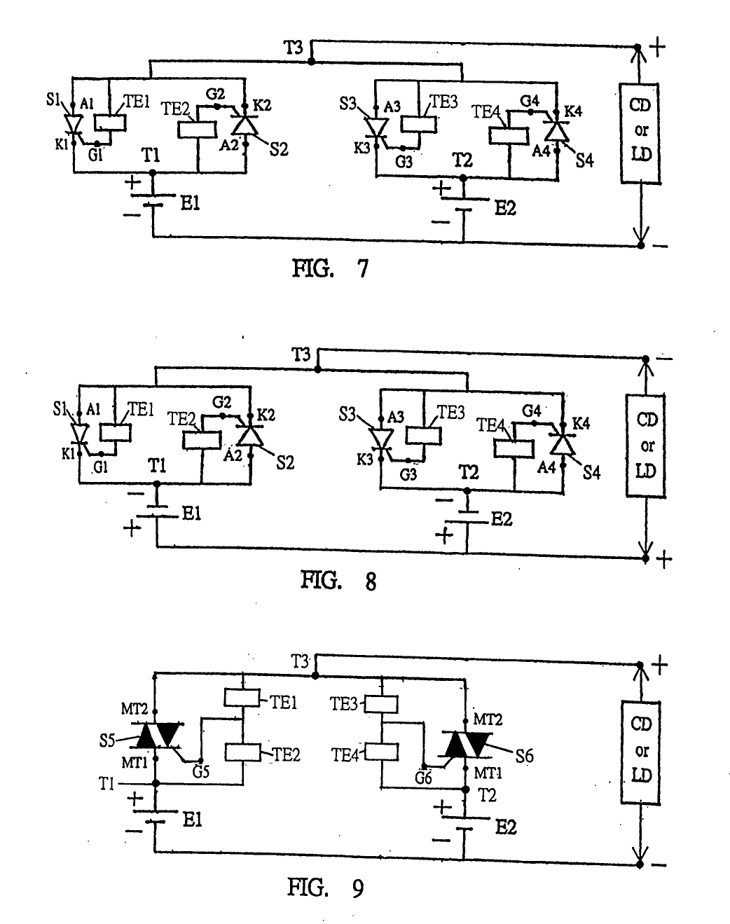

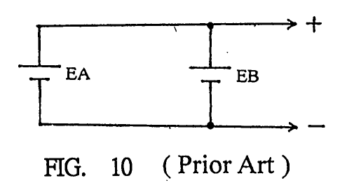

FIG. 9 shows a circuit diagram of a third cell parallel device circuit of the present invention. In FIG. 9, the third terminal T3 of present invention connected to positive voltage terminal of charge device CD or load LD, the first terminal T1 of present invention connected to positive voltage terminal of first cell E1, the negative voltage terminal of first cell E1 connected to negative voltage terminal of charge device CD or load LD, the second terminal T2 of present invention connected to positive voltage terminal of second cell E2, the negative voltage terminal of second cell E2 connected to negative voltage terminal of charge device CD or load LD; the first terminal of first trigger element TE1 connected to third terminal T3 and second terminal of first trigger element TE1 connected to gate G5 of first Triode for Alternating Current (TRIAC) S5; the first terminal of second trigger element TE2 connected to first terminal T1 and second terminal of second trigger element TE2 connected to gate G5 of first TRIAC S5; the first terminal of third trigger element TE3 connected to third terminal T3 and second terminal of third trigger element TE3 connected to gate G6 of second TRIAC S6; the first terminal of fourth trigger element TE4 connected to second terminal T2 and second terminal of fourth trigger element TE4 connected to gate G6 of second TRIAC S6; the second terminal MT2 of first TRIAC S5 connected to third terminal T3, the first terminal MT1 of first TRIAC S5 connected to T1; the second terminal MT2 of second TRIAC S6 connected to third terminal T3, the first terminal MT1 of second TRIAC S6 connected to second terminal T2.

In FIG. 9, the operation theorem of cell charge of present invention, while the positive voltage at positive voltage terminal of charge device CD, when the positive voltage over breakover voltage of first trigger element TE1 and third trigger element TE3, the first TRIAC S5 and second TRIAC S6 is turn on, the current of positive voltage passes through the second terminal of first TRIAC MT2, first terminal of first TRIAC MT1, positive voltage terminal of first cell E1, negative voltage terminal of first cell E1, and back to negative voltage terminal of charge device CD, another current of positive voltage passes through the second terminal of second TRIAC MT2, first terminal of second TRIAC MT1, positive voltage terminal of second cell E2, negative voltage terminal of second cell E2, and back to negative voltage terminal of charge device CD.

In FIG. 9, the operation theorem of cell discharge of present invention, while a load LD connected between positive voltage terminal and negative voltage terminal, the positive voltage of first cell E1 and second cell E2 over breakover voltage of second trigger element TE2 and fourth trigger element TE4, the first TRIAC S5 and second TRIAC S6 is turn on, the current of positive voltage of first cell E1 passes through the first terminal of first TRIAC MT1, second terminal of first TRIAC MT2, positive voltage terminal of load LD, negative voltage terminal of load LD, and back to negative voltage terminal of first cell E1, another current of positive voltage of second cell E2 passes through the first terminal of second TRIAC MT1, second terminal of second TRIAC MT2, positive voltage terminal of load LD, negative voltage terminal of load LD, and back to negative voltage terminal of second cell E2.

In FIG. 9, when the charge device CD and load LD is to take away, the first terminal of first TRIAC MT1 connected to positive voltage terminal of first cell E1, the first terminal of second TRIAC MT1 connected to positive voltage terminal of second cell E2, use breakover voltage technically specified of second trigger element TE2 and fourth trigger element TE4, the voltage potential difference of the first cell E1 and second cell E2 less than breakover voltage of second trigger element TE2 and fourth trigger element TE4, the first TRIAC S5 and second TRIAC S6 is turn off state, its can be not occur loop current between the first cell E1 and the second cell E2 parallel circuit.

What is claimed is:

1. A cell parallel device, characterized in that it comprises:
a first terminal connected to a terminal of the first cell;
a second terminal connected to a terminal of the second cell; and
a third terminal connected to a positive voltage terminal or a negative voltage terminal of charge device or load.

2. A cell parallel device as claimed in claim 1, characterized in that said first terminal comprising a cathode of said first Silicon Control Rectifier (SCR), an anode of said second SCR and first terminal of said second trigger element.

3. A cell parallel device as claimed in claim 2, characterized in that said first SCR can replace said second diode.

4. A cell parallel device as claimed in claim 2, characterized in that said second SCR can replace said first diode.

5. A cell parallel device as claimed in claim 2, characterized in that gate of said second SCR connected to second terminal of said second trigger element.

6. A cell parallel device as claimed in claim 2, characterized in that said second trigger element is a Diode for Alternating Current (DIAC) or a Silicon Diode for Alternating Current (SIDAC) or a diode.

7. A cell parallel device as claimed in claim 1, characterized in that said second terminal comprising a cathode of said third SCR, an anode of said fourth SCR and a first terminal of said fourth trigger element.

8. A cell parallel device as claimed in claim 7, characterized in that said third SCR can replace said fourth diode.

9. A cell parallel device as claimed in claim 6, characterized in that said fourth SCR can replace said third diode.

10. A cell parallel device as claimed in claim 7, characterized in that gate of said fourth SCR connected to second terminal of said fourth trigger element.

11. A cell parallel device as claimed in claim 7, characterized in that said fourth trigger element is a DIAC or a SIDAC or a diode.

12. A cell parallel device as claimed in claim 1, characterized in that said third terminal comprising an anode of said first SCR, a cathode of said second SCR, an anode of third SCR, a cathode of fourth SCR, a first terminal of said first trigger element and a first terminal of said third trigger element.

13. A cell parallel device as claimed in claim 12, characterized in that gate of said first SCR connected to second terminal of first trigger element.

14. A cell parallel device as claimed in claim 12, characterized in that gate of said third SCR connected to second terminal of said third trigger element.

15. A cell parallel device as claimed in claim 12, characterized in that said first trigger element and said third trigger element is a DIAC or a SIDAC or a diode.

16. A cell parallel device as claimed in claim 1, characterized in that said first terminal comprising a first terminal of said first Triode for Alternating Current (TRIAC) and a first terminal of said second trigger element.

17. A cell parallel device as claimed in claim 1, characterized in that said second terminal comprising a first terminal of said second TRIAC and a first terminal of said fourth trigger element.

18. A cell parallel device as claimed in claim 1, characterized in that said third terminal comprising a second terminal of said first TRIAC, a first terminal of said first trigger element, a second terminal of said second TRIAC and a first terminal of said third trigger element.

19. A cell parallel device as claimed in claim 18, characterized in that said second terminal of said first trigger element and second terminal of said second trigger element connected to the gate of said first TRIAC.

20. A cell parallel device as claimed in claim 18, characterized in that said second terminal of said third trigger element and second terminal of said fourth trigger element connected to the gate of said second TRIAC.
